(19) United States
(12) Patent Application Publication
(10) Pub. No.: US 2015/0017911 A1
(43) Pub. Date: Jan. 15, 2015

(54) MONITORING SYSTEM AND MONITORING METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: XIAO-JUAN LIU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/252,487

(22) Filed: Apr. 14, 2014

(30) Foreign Application Priority Data
Jul. 9, 2013 (CN) 2013102859123

(51) Int. Cl. H04B 5/00

(52) U.S. Cl. CPC H04B 5/0025
USPC 455/41.1

(57) ABSTRACT

Monitoring system includes a monitoring device and an electronic device. The monitoring device includes a display and a Near Field Communication (NFC) receiving module. The electronic device includes a controlling module, a transmitting module, and an NFC obtaining module connected to the controlling module by the transmitting module. The NFC obtaining module is connected to the NFC receiving module. The controlling module obtains system information of the electronic device, and the transmitting module sends the system information to the NFC obtaining module. The NFC obtaining module sends the system information to the NFC receiving module, and the monitoring device displays the system information. The disclosure further provides a monitoring method.

### FIELD

Embodiments of the present disclosure relate to monitoring systems and methods, and particularly to a monitoring system and a monitoring method of an electronic device.

### BACKGROUND

Blade and rack-mounted servers are popular forms of data center servers. In order to achieve high performance, many rack-mounted servers are clustered in an enclosure. The plurality of servers is managed by a base board controller.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a schematic diagram of an embodiment of a monitoring system.

FIG. 2 is a block diagram of one embodiment of function modules of the monitoring system of FIG. 1.

FIG. 3 is a flowchart of one embodiment of a monitoring method using the monitoring system of FIG. 2.

FIG. 4 is a flowchart of one embodiment of a transmitting method of the monitoring method of FIG. 3.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module, ” as used hereinafter, refers to logic embodied in hardware or firmware, or to a collection of software instructions, written in a programming language, such as, for example, Java, C, or Assembly. One or more software instructions in the modules can be embedded in firmware. Modules can comprise connected logic units, such as gates and flip-flops, and programmable units, such as programmable gate arrays or processors. The modules described herein can be implemented as either software and/or hardware modules and can be stored in any type of computer-readable medium or computer storage device.

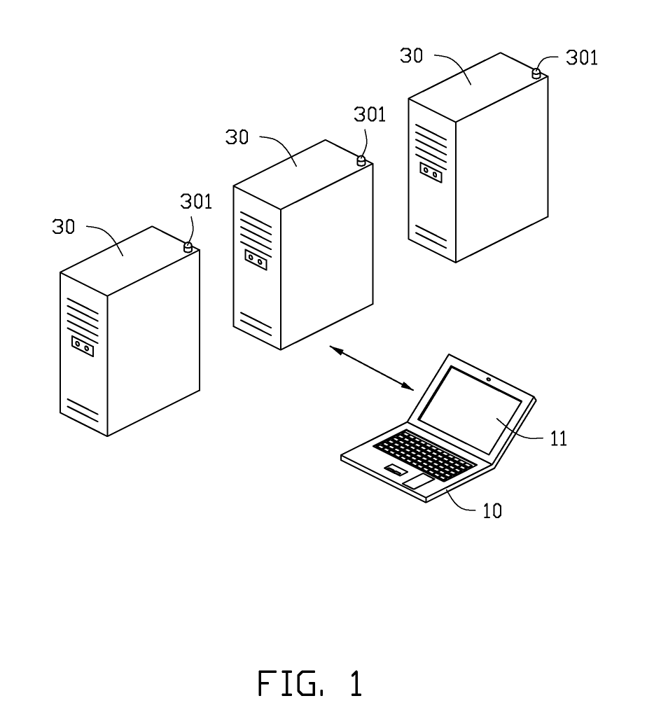

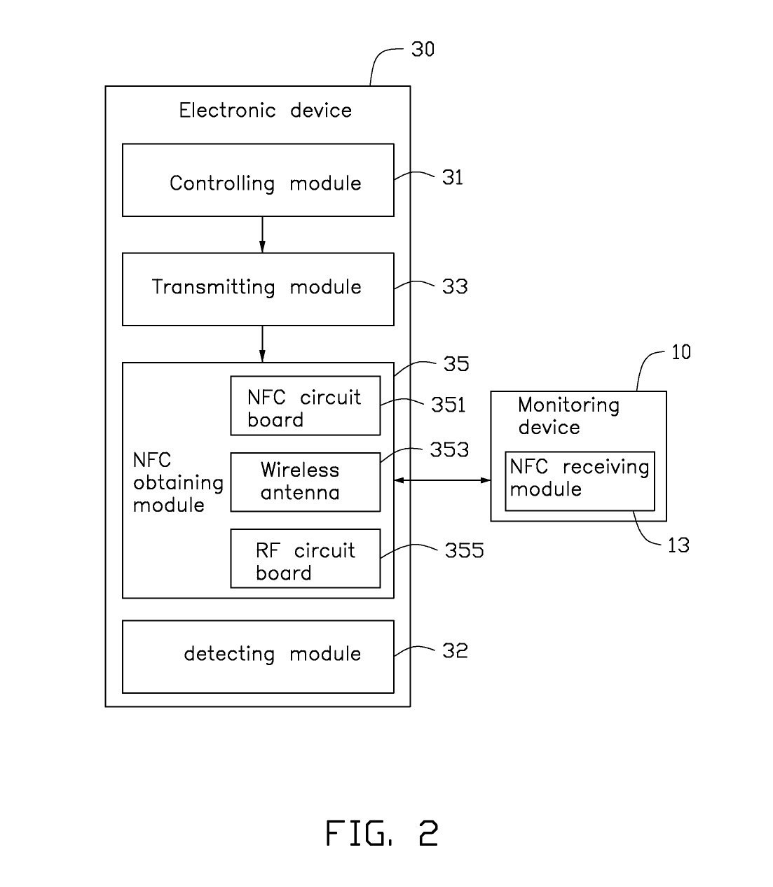

FIGS. 1-2 illustrate one embodiment of a monitor system. The monitor system comprises a monitoring device 10 and a plurality of electronic devices 30 in communication with the monitoring device 10. In one embodiment, each of the plurality of electronic devices 30 can be a server. A warning light 301 is located on each electronic device 30 and illuminates when the corresponding electronic device 30 is abnormal.

The monitoring device 10 comprises a display 11 and an Near Field Communication (NFC) receiving module 13. A signal from the plurality of electronic devices 30 can be transmitted to the monitoring device 10 by the NFC receiving module 13.

Each electronic device 30 comprises a controlling module 31, a detecting module 32, a transmitting module 33, and an NFC obtaining module 35. The NFC obtaining module 35 is connected to the controlling module 31 via the transmitting module 33. The controlling module 31 is used to obtain a plurality of system information, such as an IP address and a status, of the electronic device 30. The detecting module 32 is used to detect whether a monitoring request is sent from the monitoring device 10. The transmitting module 33 is used to send the system information to the NFC obtaining module 35. In one embodiment, the transmitting module 33 is an Inter-Integrated Circuit (I²C) bus-bar.

The NFC obtaining module 35 comprises an NFC circuit board 351, a wireless antenna 353, and a Radio Frequency (RF) circuit board 355. The RF circuit board 355 is used for providing an RF magnetic field to the NFC circuit board 351. The NFC circuit board 351 is used to receive the system information from the transmitting module 33 and detects whether the RF magnetic field is present. The wireless antenna 353 is used to couple the NFC obtaining module 35 to the NFC receiving module 13 when the detecting module 32 detects the monitoring request sent from the monitoring device 10, so that the system information can be transmitted between the NFC obtaining module 35 and the NFC receiving module 13.

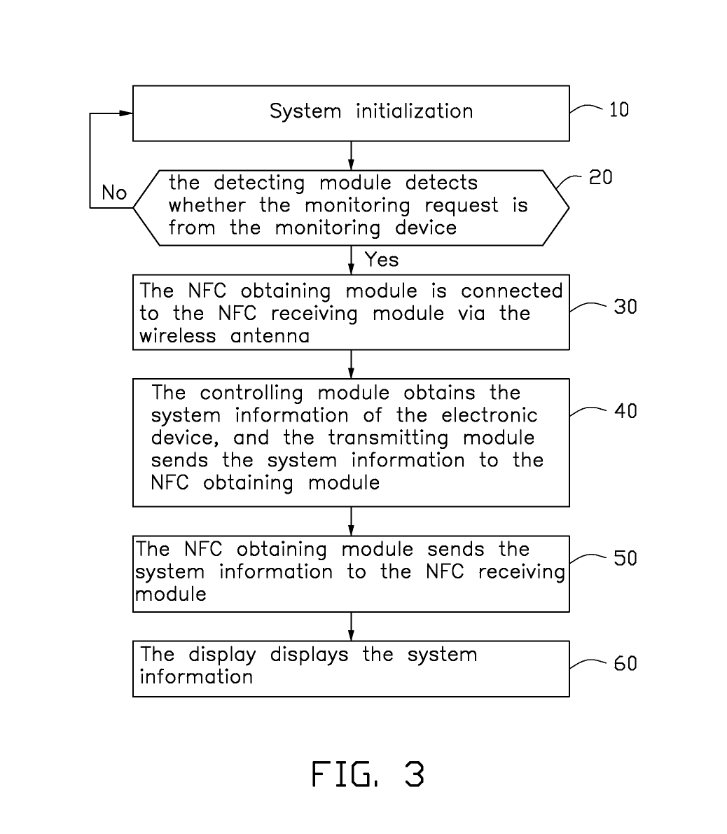

FIG. 3 is a flowchart of one embodiment of a monitor method using the monitor system in FIGS. 1-2. In use, when one of the plurality of electronic devices is abnormal, the corresponding warning light is illuminated. The monitoring device is moved adjacent to the corresponding electronic device to monitor the status of the electronic device according to the following blocks. Depending on the embodiment, additional blocks may be added, others removed, and the ordering of the blocks can be changed.

In block 10, a system of the monitoring device is initialized.

In block 20, the detecting module detects whether the monitoring request is sent from the monitoring device. If not, block 10 is repeated. If yes, the process goes on to block 30.

In block 30, the NFC obtaining module connects to the NFC receiving module via the wireless antenna.

In block 40, the controlling module obtains the system information of the electronic device, and the transmitting module sends the system information to the NFC obtaining module.

In block 50, the NFC obtaining module sends the system information to the NFC receiving module.

In block 60, the display displays the system information of the electronic device received from the NFC receiving module.

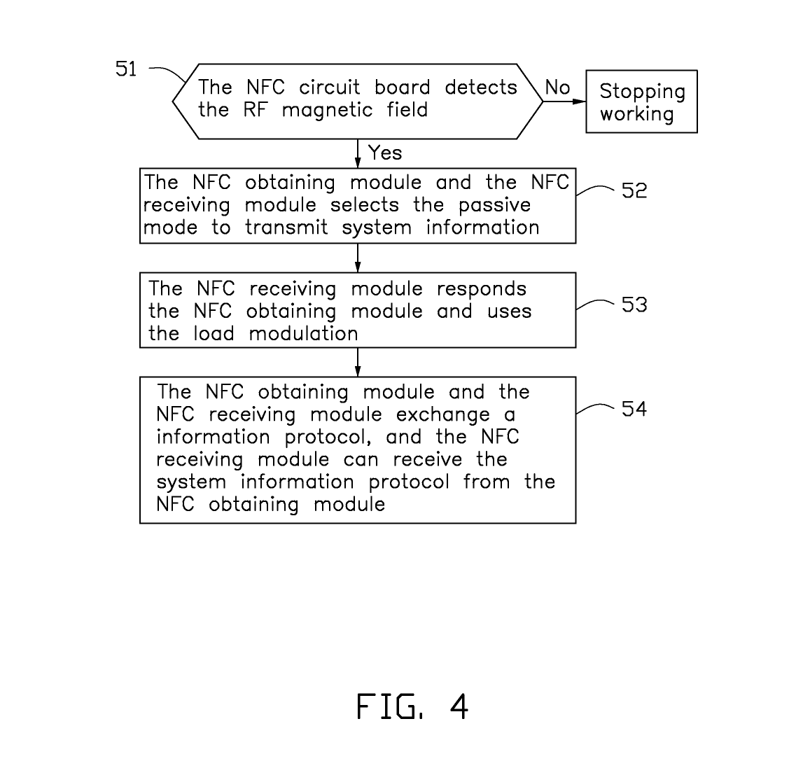

FIG. 4 is a flowchart of one embodiment of block 50. The system information can be transmitted in a passive mode. In the passive mode, the NFC obtaining module is an NFC main device, and the RF circuit board provides the RF magnetic field. In one embodiment, the RF magnetic field is 13.56 megahertz (Mhz). Thus, the system information is transmitted to the monitoring device by the NFC obtaining module. The monitoring device can be an assistant device. The NFC receiving module does not provide the RF magnetic field, and the system information is sent to the electronic device using a load modulation. Thus, the system information can be exchanged between the NFC obtaining module and the NFC receiving module. The method of exchanging the system information comprises the following blocks. Depending on the embodiment, additional blocks may be added, others removed, and the ordering of the blocks can be changed.

In block 51, the NFC circuit board detects whether the RF magnetic field is provided to the NFC obtaining module. If not, the monitoring system stops working. If yes, the process goes on to block 52.

In block 52, the NFC obtaining module and the NFC receiving module transmit the system information in the passive mode.

In block 53, the NFC receiving module responds to the NFC obtaining module and uses the load modulation.

In block 54, the NFC obtaining module and the NFC receiving module exchange an information protocol, so that the NFC receiving module can receive the system information protocol from the NFC obtaining module.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A monitoring system comprising:
a monitoring device comprising a display and a Near Field Communication (NFC) receiving module; and
an electronic device comprising a controlling module, a transmitting module, and a NFC obtaining module connected to the controlling module by the transmitting module, the NFC obtaining module connected to the NFC receiving module;
wherein the controlling module is configured to obtain a system information of the electronic device, the transmitting module is configured to send the system information to the NFC obtaining module, and the NFC obtaining module is configured to send the NFC receiving module for the display being displayed.

2. The monitoring system of claim 1, wherein the electronic device further comprises a detecting module configured for detecting a monitoring request from the monitoring device, the NFC obtaining module comprises a wireless antenna, the wireless antenna is configured to connect the NFC obtaining module and the NFC receiving module when the detecting module detects the monitoring request.

3. The monitoring system of claim 1, wherein the NFC obtaining module comprises a Radio Frequency (RF) circuit board and a NFC circuit board, the RF circuit board is configured to offer a RF magnetic field for the NFC obtaining module and the NFC receiving module.

4. The monitoring system of claim 1, wherein the transmitting module is an Inter-Integrated Circuit (I²C) bus-bar.

5. The monitoring system of claim 1, wherein the system information comprises an IP address and a heath status of the electronic device.

6. The monitoring system of claim 1, wherein the electronic device is a server.

7. A monitoring method comprising:
obtaining a system information of an electronic device by a controlling module in the electronic device;
transmitting the system information to a Near Field Communication (NFC) obtaining module in the electronic device by a transmitting module in the electronic device;
connecting the NFC obtaining module to a NFC receiving module in a monitoring device;
transmitting the system information to the NFC receiving module by the NFC obtaining module; and
displaying the system information by a display in the monitoring device.

8. The monitoring method of claim 7, further comprising a block of detecting a monitoring request from the monitoring device by a detecting module in the electronic device before the block of obtaining the system information of the electronic device by the controlling module in the electronic device.

9. The monitoring method of claim 7, further comprising a block of connecting the NFC obtaining module to the NFC receiving module by a wireless antenna when the block of connecting the NFC obtaining module to a NFC receiving module in a monitoring device.

10. The monitoring method of claim 7, further comprising a block of offering a Radio Frequency (RF) magnetic field for the NFC obtaining module and the NFC receiving module by a RF circuit board in the electronic device before the block of obtaining the system information of the electronic device by the controlling module in the electronic device.

12. The monitoring method of claim 7, wherein the transmitting module is an Inter-Integrated Circuit (I²C) bus-bar.

13. The monitoring method of claim 7, wherein the system information comprises a Internet Protocol (IP) address and a heath status of the electronic device.

14. The monitoring method of claim 7, wherein the electronic device is a server.
